(19) United States
(12) Patent Application Publication
(10) Pub. No.: US 2024/0043277 A1
(43) Pub. Date: Feb. 8, 2024

(54) FULLERENE PRODUCTION DEVICE AND PRODUCTION METHOD

(71) Applicant: Reasonac Corporation, Tokyo (JP)

(72) Inventors: Tadashi IINO, Kawasaki-shi, Japan (JP); Eiji KAMBARA, Kawasaki-shi, Japan (JP)

(73) Assignee: Resonac Corporation, Tokyo (JP)

(21) Appl. No.: 18/266,752

(22) PCT Filed: Nov. 9, 2021
(86) PCT No.: PCT/JP2021/041228

§ 371 Date: Jun. 12, 2023

(30) Foreign Application Priority Data
Dec. 17, 2020 (JP) 2020-209111

(51) Int. Cl. C01B 32/154; B01J 6/00; B01J 4/00

(52) U.S. Cl. CPC C01B 32/154; B01J 6/00; B01J 4/001

(57) ABSTRACT

The present invention provides a fullerene production device that enables improving fullerene yields. The fullerene production device includes: a reacting furnace (2) in which fullerenes are generated through incomplete combustion of a raw material gas containing a hydrocarbon; a first injection unit (23c) configured to incompletely combust the raw material gas while injecting the raw material gas into the reacting furnace (2) to form a first combustion flame; and a second injection unit (25a) configured to combust an auxiliary gas containing a hydrocarbon that is the same as or different from that in the raw material gas while injecting the auxiliary gas into the reacting furnace (2) to form a second combustion flame.

### TECHNICAL FIELD

The present invention relates to a fullerene production device and a fullerene production method.

Priority is claimed on Japanese Patent Application No. 2020-209111, filed Dec. 17, 2020, the content of which is incorporated herein by reference.

### BACKGROUND ART

As fullerene production methods, a combustion method for generating fullerenes by incompletely combusting a raw material gas containing a hydrocarbon (hereinafter also referred to as a “raw material gas”) in a reacting furnace, and a pyrolysis method for generating fullerenes by pyrolyzing a raw material gas containing a hydrocarbon are known (see, for example, Patent Documents 1 to 4).

### CITATION LIST

### Patent Document

### Patent Document 1

Japanese Unexamined Patent Application, First Publication No. 2003-160316

### Patent Document 2

Japanese Unexamined Patent Application, First Publication No. 2003-171106

### Patent Document 3

Japanese Unexamined Patent Application, First Publication No. 2003-221216

### Patent Document 4

Chinese Patent No. 102757032

### SUMMARY OF INVENTION

### Technical Problem

Incidentally, in order to increase fullerene yields, it is preferable to raise a temperature inside a production device. However, in the fullerene production devices and production methods described in Patent Documents 1 to 4, it is difficult to set the inside of a reacting furnace to a high temperature state and maintain the high temperature, and thus fullerene yields are not high. Accordingly, it is desired to increase fullerene yields and further reduce production costs of fullerenes.

One aspect of the present invention has been made in view of the above problems, and one object thereof is to provide a fullerene production device and a fullerene production method in which fullerene yields can be improved.

### Solution to Problem

One aspect of the present invention provides the following means in order to solve the above problems.

(1) A fullerene production device including:
a reacting furnace in which fullerenes are generated through incomplete combustion of a raw material gas containing a hydrocarbon;
a first injection unit configured to incompletely combust the raw material gas while injecting the raw material gas and a first oxygen-containing gas into the reacting furnace to form a first combustion flame; and
a second injection unit configured to combust an auxiliary gas containing a hydrocarbon that is the same as or different from that in the raw material gas while injecting the auxiliary gas and a second oxygen-containing gas into the reacting furnace to form a second combustion flame.

(2) The fullerene production device according to the preceding item (1), characterized by including:
a first flow rate adjusting unit configured to adjust a ratio A₁ of the number of carbon atoms in the raw material gas to the number of oxygen atoms in the first oxygen-containing gas to 0.60 to 2.00 to supply the raw material gas and the first oxygen-containing gas to the first injection unit; and
a second flow rate adjusting unit configured to adjust a ratio A₂ of the number of carbon atoms in the auxiliary gas to the number of oxygen atoms in the second oxygen-containing gas to 0.30<A₂<A₁ to supply the auxiliary gas and the second oxygen-containing gas to the second injection unit.

(3) The fullerene production device according to the preceding item (1) or (2), characterized in that one of the first injection unit and the second injection unit is disposed to surround the other.

(4) The fullerene production device according to the preceding item (1) or (2), characterized in that at least a part of the first injection unit and at least a part of the second injection unit are alternately arranged in concentric circle shapes.

(5) The fullerene production device according to any one of the preceding items (1) to (3), characterized in that a partitioning portion is provided between the first injection unit and the second injection unit.

(6) The fullerene production device according to the preceding item (1) or (2), characterized in that the first injection unit injects the raw material gas from one end side of the reacting furnace toward the other end side thereof, and
the second injection unit injects the auxiliary gas from a periphery between the one end side and the other end side of the reacting furnace.

(7) The fullerene production device according to any one of the preceding items (1) to (6), characterized by including a decompression mechanism configured to decompress an inside of the reacting furnace while performing suction from the inside of the reacting furnace.

(8) A fullerene production method characterized by including a step of generating fullerenes in a reacting furnace through incomplete combustion of a raw material gas containing a hydrocarbon,
wherein, in the above step, while the raw material gas and a first oxygen-containing gas are injected into the reacting furnace, the raw material gas is incompletely combusted to form a first combustion flame,
while an auxiliary gas containing a hydrocarbon that is the same as or different from that in the raw material gas and a second oxygen-containing gas are injected into the reacting furnace, the auxiliary gas is combusted to form a second combustion flame, thereby heating an inside of the reacting furnace,
a ratio A₁ of the number of carbon atoms in the raw material gas to the number of oxygen atoms in the first oxygen-containing gas is set to 0.60 to 2.00, and
a ratio A₂ of the number of carbon atoms in the auxiliary gas to the number of oxygen atoms in the second oxygen-containing gas is set to 0.30<A₂<A₁.

(9) The fullerene production method according to the preceding item (8), characterized in that a temperature inside the reacting furnace is set to 1000 to 2000° C.

(10) The fullerene production method according to the preceding item (8) or (9), characterized in that, in the above step, the inside of the reacting furnace is set in a decompressed state while suction from the inside of the reacting furnace is performed.

(11) The fullerene production method according to preceding item (10), characterized in that the pressure inside the reacting furnace is set to 1 to 30 kPa.

### Advantageous Effects of Invention

According to one aspect of the present invention, it is possible to improve fullerene yields.

### BRIEF DESCRIPTION OF DRAWINGS

FIG. 1 is a configuration diagram showing an example of a fullerene production device according to one embodiment of the present invention.

FIG. 2 is a cross-sectional view showing the configuration of a reacting furnace provided with a burner 9A and a burner 10A according to a first embodiment of the present invention.

FIGS. 3A and 3B are plan views illustrating configurations of tip surfaces of injection units of the burner 9A and the burner 10A shown in FIG. 2.

FIG. 4 is a cross-sectional view showing the configuration of a reacting furnace provided with a burner 9B and a burner 10B according to a second embodiment of the present invention.

FIG. 5 is a plan view showing the configurations of tip surfaces of injection units of the burner 9B and the burner 10B shown in FIG. 4.

FIG. 6 is a cross-sectional view showing the configuration of a reacting furnace provided with a burner 9C and a burner 10C according to a third embodiment of the present invention.

FIGS. 7A and 7B are plan views illustrating configurations of tip surfaces of injection units of the burner 9C and the burner 10C shown in FIG. 6.

FIG. 8 is a cross-sectional view showing the configuration of a reacting furnace provided with a burner 9D and a burner 10D according to a fourth embodiment of the present invention.

FIGS. 9A, 9B and 9C are vertical cross-sectional views illustrating shapes and arrangement of a second injection unit 25d and second injection ports 22a provided in the burner 10D shown in FIG. 8.

FIGS. 10A and 10B are cross-sectional views illustrating arrangement of the second injection ports 22a of the second injection unit 25d provided in the burner 10D shown in FIG. 8.

### DESCRIPTION OF EMBODIMENTS

A fullerene production device and a fullerene production method to which the present invention is applied will be described in detail below with reference to the drawings.

In addition, the drawings used in the following description may schematically show featured portions for convenience in order to make the features easier to understand, and the dimensional ratios of the constituent elements and the like are not necessarily the same as actual ones.

(Fullerene Production Device)

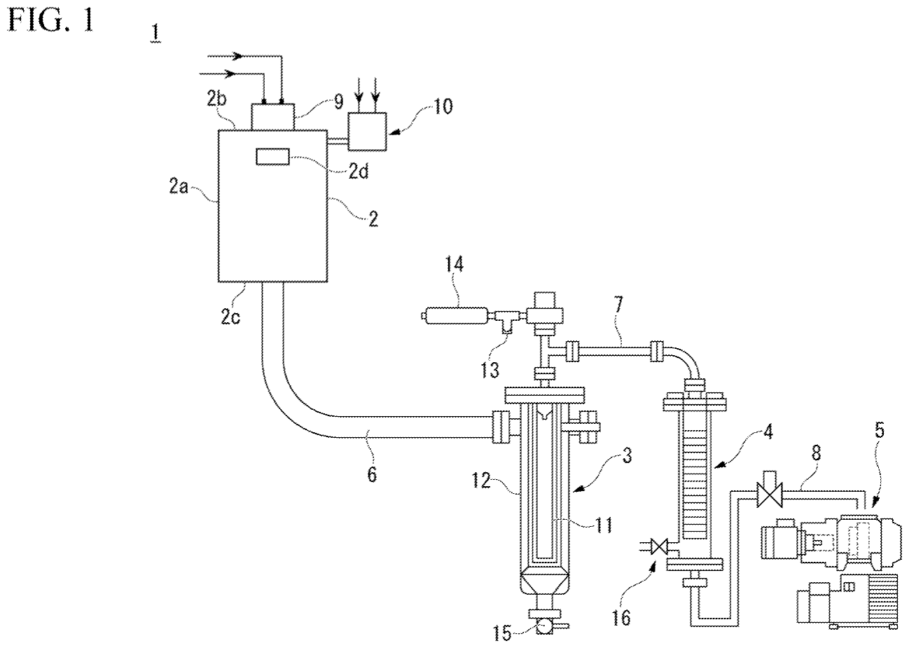

First, as one embodiment of the present invention, for example, a fullerene production device 1 shown in FIG. 1 will be described.

Also, FIG. 1 is a configuration diagram showing one example of the fullerene production device 1.

As shown in FIG. 1, the fullerene production device 1 of the present embodiment includes a reacting furnace 2 that generates soot-like substances containing fullerenes through incomplete combustion of a raw material gas containing a hydrocarbon, a recovery mechanism 3 that recovers the soot-like substances generated in the reacting furnace 2, a cooling mechanism 4 that cools the gas that has passed through the recovery mechanism 3, and a decompression mechanism 5 that sets the inside of the reacting furnace 2 to be in a decompressed state while sucking the gas cooled by the cooling mechanism 4.

In addition, the fullerene production device 1 has a first pipe 6 connecting the reacting furnace 2 to the recovery mechanism 3, a second pipe 7 connecting the recovery mechanism 3 to the cooling mechanism 4, and a third pipe 8 connecting the cooling mechanism 4 to the decompression mechanism 5.

The reacting furnace 2 has a cylindrical circumferential wall portion 2a, an upper wall portion 2b that closes an upper end side (one end side) of the circumferential wall portion 2a, and a lower wall portion 2c that closes a lower end side (the other end side) of the circumferential wall portion 2a, and disposed in a standing state in a vertical direction. In addition, the reacting furnace 2 may also have a sapphire glass window 2d for measuring its internal temperature.

Further, as a material of the reacting furnace 2, for example, a heat-resistant material such as zirconia (ZrO₂), tungsten (W), tantalum (Ta), platinum (Pt), titanium (Ti), titanium nitride (TiN), alumina (Al₂O₃), and silicon carbide (SiC) are exemplary examples. In addition, at least a part of an outer side and an inner side thereof may be lined with, for example, a heat insulating material such as an alumina refractory brick or an alumina monolithic refractory material.

Also, it is preferable to arrange the reacting furnace 2 in the above-mentioned vertical direction to decrease the effect of retention of the soot-like substances. In addition, when an arrangement direction of the reacting furnace 2 is the vertical direction, it is preferable to supply the raw material gas from above. On the other hand, the reacting furnace 2 can also be disposed, for example, in a state in which it is inclined horizontally or obliquely.

The first pipe 6 is connected to a discharge port 30d (hereinafter referred to as an “exhaust gas discharge port 30d”) for discharging an exhaust gas, which is provided in the lower wall portion 2c of the reacting furnace 2. On the other hand, a burner 9 and a burner 10 are provided on the upper wall portion 2b side of the reacting furnace 2. In the reacting furnace 2, the raw material gas and a first oxygen-containing gas that are injected from the burner 9 are incompletely combusted to produce the soot-like substances containing fullerenes.

Also, the inside of the reacting furnace 2 is heated by combusting an auxiliary gas and a second oxygen-containing gas that are injected into the reacting furnace 2 from the burner 10. Thus, a high temperature exhaust gas containing the soot-like substances, carbon monoxide, carbon dioxide, water vapor, and the like generated by the combustion of the raw material gas and the auxiliary gas passes through the first pipe 6 and reaches the recovery mechanism 3.

The recovery mechanism 3 has a collector 12 in which a filter 11 is housed, a tank 14 connected to an upper end (one end) side of the collector 12 via an electromagnetic valve 13, and a discharge valve 15 provided on a lower end (the other end) side of the collector 12.

The first pipe 6 is connected to a side surface of the collector 12 on an upper portion side thereof. The second pipe 7 is connected to an upper portion of the collector 12. A sintered metal filter, for example, is used for the filter 11. The electromagnetic valve 13 is branched from the second pipe 7 and connected thereto. For example, a high-pressure inert gas such as nitrogen gas (N₂) or argon gas (Ar) is stored in the tank 14.

In the recovery mechanism 3, after the soot-like substances contained in the exhaust gas supplied from the first pipe 6 are recovered by the filter 11, the electromagnetic valve 13 is periodically opened to inject the inert gas from the tank 14 toward the collector 12. Thus, the soot-like substances adhering to the filter 11 are removed. After that, by opening the discharge valve 15, it is possible to recover the soot-like substances accumulated in the collector 12.

The cooling mechanism 4 has a structure identical or similar to that of a normal heat exchanger, one end (an upper end) side of which is connected to the second pipe 7, and the other end (a lower end) side of which is connected to the third pipe 8.

The cooling mechanism 4 cools the gas that has passed through the recovery mechanism 3. Further, in the cooling mechanism 4, unreacted hydrocarbons and water vapor in the gas can be liquefied and discharged from a drain 16 provided on a lower portion side thereof.

Also, in addition to the cooling mechanism 4, since the exhaust gas passing through the first pipe 6 is at a high temperature, a configuration in which the first pipe 6 is cooled may be adopted.

The decompression mechanism 5 is configured of a vacuum pump and sucks the gas cooled by the cooling mechanism 4 through the third pipe 8. Thus, it is possible to discharge the soot-like substances generated in the reacting furnace 2 to the recovery mechanism 3 side through the first pipe 6 while generating a negative pressure relative to the reacting furnace 2.

As a hydrocarbon contained in the raw material gas, aromatic hydrocarbons with 6 to 15 carbon atoms such as toluene, benzene, xylene, naphthalene, methylnaphthalene, anthracene, and phenanthrene, coal-based hydrocarbons such as creosote oil and carboxylic acid oil, ethylenically unsaturated hydrocarbons, acetylenically unsaturated hydrocarbons, aliphatic saturated hydrocarbons such as pentane and hexane, and the like are exemplary examples. Also, two or more types of the hydrocarbons may be mixed and used. The raw material gas preferably contains aromatic hydrocarbons among the above-described hydrocarbons. Also, the raw material gas may be diluted with an inert gas such as nitrogen gas or argon, if necessary.

A hydrocarbon contained in the auxiliary gas may be the same as or different from that in the raw material gas described above. For example, alkanes having 1 to 8 carbon atoms, alkenes having 2 to 8 carbon atoms, alkynes having 2 to 8 carbon atoms, aromatic hydrocarbons having 6 to 15 carbon atoms such as benzene, toluene, xylene, naphthalene, methylnaphthalene, anthracene, and phenanthrene, coal-based hydrocarbons such as creosote oil and carboxylic acid oil, aliphatic saturated hydrocarbons such as pentane and hexane, ethers such as dimethyl ether, diethyl ether, ethyl methyl ether, alcohols such as methanol and ethanol, or ketones such as acetone, methyl ethyl ketone, and diethyl ketone are exemplary examples. Also, two or more types of the hydrocarbons may be mixed and used. The auxiliary gas preferably contains alkanes having 1 to 8 carbon atoms, alkenes having 2 to 8 carbon atoms, or alkynes having 2 to 8 carbon atoms among the above-described hydrocarbons. Also, the auxiliary gas may be diluted with an inert gas such as nitrogen gas or argon, if necessary.

Further, the first oxygen-containing gas and the second oxygen-containing gas are gases containing oxygen molecules, and oxygen gas, air, and the like are exemplary examples. The first oxygen-containing gas and the second oxygen-containing gas may be supplied to the reacting furnace 2 separately from the raw material gas and the auxiliary gas, or may be mixed respectively with the raw material gas and the auxiliary gas in advance and then may be supplied to the reacting furnace 2.

As the generated fullerenes, for example, high-order fullerenes such as C₆₀ fullerene (C₆₀), C₇₀ fullerene (C₇₀), C₇₆, C₇₈, C₈₄, C₉₀, and C₉₆ are exemplary examples.

(Fullerene Production Method)

Next, a fullerene production method using the fullerene production device 1 will be described.

The fullerene production method of the present embodiment includes a step of generating fullerenes by incompletely combusting the raw material gas containing the hydrocarbon in the reacting furnace 2, and is characterized in that, in the step, while the raw material gas and the first oxygen-containing gas are injected into the reacting furnace 2, the raw material gas is incompletely combusted to form a first combustion flame, and while the auxiliary gas containing the hydrocarbon and the second oxygen-containing gas are injected into the reacting furnace 2, the auxiliary gas is combusted to form a second combustion flame, thereby heating the inside of the reacting furnace 2.

A ratio A₁ between the number of carbon atoms in the raw material gas injected into the reacting furnace 2 and the number of oxygen atoms in the first oxygen-containing gas is preferably 0.60 to 2.00, more preferably 0.80 to 1.70, and even more preferably 1.00 to 1.50. This makes it possible to increase fullerene yields.

For example, in a case in which the raw material gas is vaporized toluene (number of carbon atoms: 7), a supply rate of the number of carbon atoms in the raw material gas when a supply rate of the raw material gas is 20 g/min, that is, when it is 0.217 mol/min, is 7×0.217×6.02×10²³ atoms/min. A supply rate of the oxygen atoms when a supply rate of oxygen molecules is 13 NL/min (0.582 mol/min) is 2×0.582×6.02×10²³ atoms/min. Accordingly, A₁ is calculated as (7×0.217)/(2×0.582)=1.31. The same also applies to A₂.

Also, the ratio A₂ between the number of carbon atoms in the auxiliary gas injected into the reacting furnace 2 and the number of oxygen atoms in the second oxygen-containing gas preferably satisfies 0.30<A₂<A₁. If A₂ is greater than 0.30, there is little to no surplus the second oxygen-containing gas, and thus its influence on the incomplete combustion of the raw material gas is small. On the other hand, when A₂ is less than A₁, the second combustion flame generated by combusting the auxiliary gas has a higher temperature than the first combustion flame (incomplete combustion flame) generated by the incomplete combustion of the raw material gas, and thus the inside of the reacting furnace 2 can be heated by the second combustion flame.

Also, A₂ satisfies 0.30<A₂<A₁, is preferably 0.35 to 0.85, and is more preferably 0.35 to 0.55. It is preferable if A₂ is 0.35 to 0.85 because the combustion of the auxiliary gas becomes complete combustion or comes close to complete combustion, and the temperature of the generated second combustion flame becomes higher.

Normally, a temperature of the first combustion flame for producing fullerenes is 500° C. to 2000° C. On the other hand, a temperature of the second combustion flame generated by combusting the auxiliary gas is preferably 1000° C. to 2500° C., and more preferably 1100° C. to 2200° C. Thus, it is possible to keep the temperature (atmosphere) in the reacting furnace 2 high.

Then, in the high-temperature reacting furnace 2, the raw material gas is incompletely combusted to generate the soot-like substances. This makes it possible to improve the fullerene yields contained in the generated soot-like substances.

Here, the temperature inside the reacting furnace 2 heated by the second combustion flame is, from the viewpoint of improving the fullerene yields, preferably 1000 to 2000° C., and more preferably 1500 to 2000° C. If the temperature in the reacting furnace 2 is less than 1000° C., the effect of improving the fullerene yields is low. On the other hand, if the temperature in the reacting furnace 2 exceeds 2000° C., a large amount of the auxiliary gas is required to raise the temperature in the reacting furnace 2, which is inefficient. The temperature inside the reacting furnace 2 can be measured by an ultra-high temperature thermocouple or a radiation thermometer.

Further, the pressure inside the reacting furnace 2 is preferably 1 to 30 kPa, and more preferably 1 to 10 kPa. If the pressure in the reacting furnace 2 becomes less than 1 kPa, a load on the decompression mechanism 5 increases. On the other hand, if the pressure inside the reacting furnace 2 exceeds 30 kPa, the flame may cause a backfire.

### First Embodiment

Next, the fullerene production device 1 according to a first embodiment of the present invention will be described.

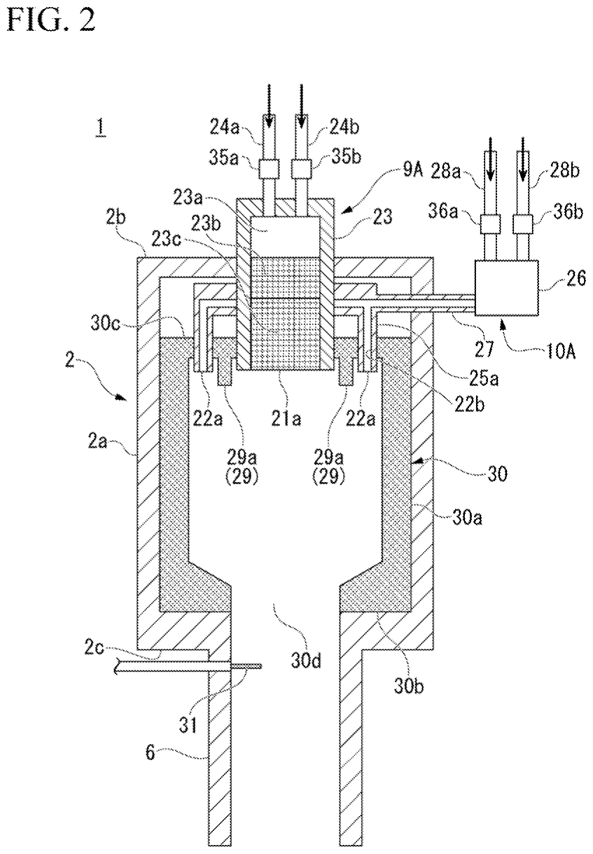

The fullerene production device 1 according to the first embodiment of the present invention includes the burner 9 (hereinafter distinguished as a “burner 9A”) and the burner 10 (hereinafter distinguished as a “burner 10A”″) shown in FIG. 2.

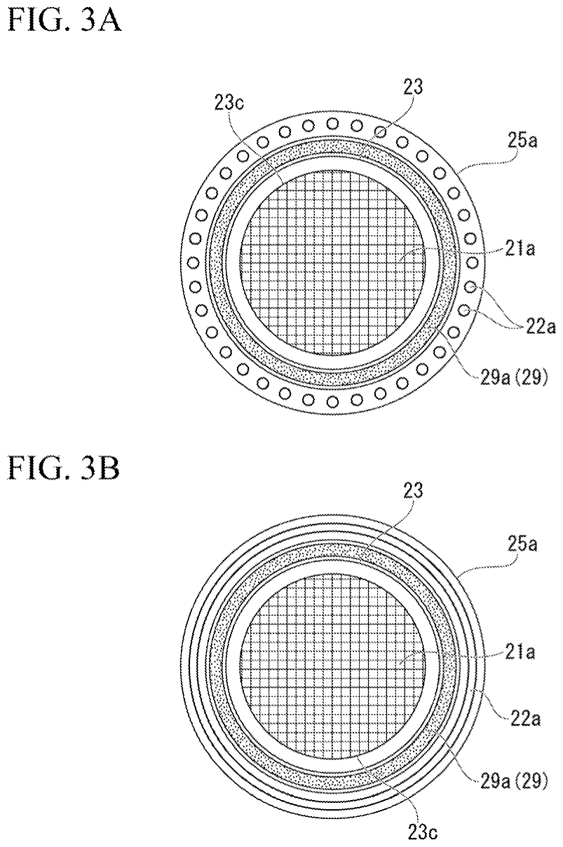

Further, FIG. 2 is a cross-sectional view showing a configuration of the reacting furnace 2 including the burner 9A and the burner 10A. FIGS. 3A and 3B are plan views illustrating configurations of tip surfaces of a first injection unit 23c and a second injection unit 25a, which will be described later.

The burner 9A of the present embodiment has a ceilinged cylindrical burner holder 23 attached to penetrate the upper wall portion 2b of the reacting furnace 2 and has, inside the burner holder 23, a first premixing chamber 23a, a pressure accumulation chamber 23b, and the first injection unit 23c provided in order from an upper side thereof. In addition, a pipe 24a for introducing the raw material gas and a pipe 24b for introducing the first oxygen-containing gas are connected to an upper portion of the burner holder 23.

The pipe 24a is provided with a first flow meter 35a for controlling a flow rate of the raw material gas (or liquid hydrocarbons). Also, the pipe 24a may be provided with a gasifying device such as a heating device located between the first flow meter 35a and the upper portion of the burner holder 23 to gasify liquid hydrocarbons.

The pipe 24b is provided with a first flow meter 35b for controlling a flow rate of the first oxygen-containing gas. Using the first flow meters 35a and 35b, a first flow rate adjusting unit adjusts the ratio A₁ between the number of carbon atoms in the raw material gas and the number of oxygen atoms in the first oxygen-containing gas to 0.60 to 2.00 and supplies the raw material gas and the first oxygen-containing gas to the first injection unit 23c.

Also, the first flow meters 35a and 35b may be those capable of adjusting the raw material gas (or liquid hydrocarbons) and the first oxygen-containing gas to predetermined flow rates, and commercially available mass flow controllers or the like can be used, for example.

The first premixing chamber 23a uniformly mixes the raw material gas introduced from the pipe 24a and the first oxygen-containing gas introduced from the pipe 24b. The pressure accumulation chamber 23b accumulates the raw material gas and the first oxygen-containing gas mixed in the first premixing chamber 23a (hereinafter also referred to as a “first mixed gas”) at a predetermined pressure. The first injection unit 23c has a plurality of first injection ports 21a and injects the first mixed gas accumulated in the pressure accumulation chamber 23b downward (in a direction toward the exhaust gas discharge port 30d) from the first injection ports 21a. The first injection unit 23c may be configured of a porous ceramic sintered body or a metal powder sintered body.

Also, in the present embodiment, a configuration in which the first premixing chamber 23a, the pressure accumulation chamber 23b, and the first injection unit 23c are provided inside the burner holder 23 has been adopted, but a configuration in which the first premixing chamber 23a is omitted may also be adopted. Further, the first premixing chamber 23a and the pressure accumulation chamber 23b may be provided outside the burner holder 23, if necessary.

The burner 10A has the second injection unit 25a, a second premixing chamber 26 disposed outside the reacting furnace 2, and a connection pipe 27 connecting the second injection unit 25a to the second premixing chamber 26.

The second injection unit 25a is, for example, a cylinder having a certain thickness and is provided with second injection ports 22a for injecting the auxiliary gas and the second oxygen-containing gas into the reacting furnace 2 on its tip surface. In addition, passages 22b that connect the second injection ports 22a to the connection pipe 27 are provided inside the second injection unit 25a. The second injection unit 25a is disposed to surround the first injection unit 23c.

Shapes and the number of the second injection ports 22a are not particularly limited, but as an example, they are circular as shown in FIG. 3A. In FIG. 3A, the tip surface of the second injection unit 25a is link-shaped, and the plurality of second injection ports 22a are evenly disposed on the tip surface of the second injection unit 25a.

Further, as shown in FIG. 3B, link-shaped second injection ports 22a may be disposed on a ring-shaped tip surface of the second injection unit 25a.

A pipe 28a for introducing the auxiliary gas and a pipe 28b for introducing the second oxygen-containing gas are connected to the second premixing chamber 26.

The pipe 28a is provided with a second flow meter 36a for controlling a flow rate of the auxiliary gas (or liquid hydrocarbons). Also, the pipe 28a may be provided with a gasifying device such as a heating device located between the second flow meter 36a and the second premixing chamber 26 to gasify liquid hydrocarbons.

The pipe 28b is provided with a second flow meter 36b for controlling a flow rate of the second oxygen-containing gas. Using the second flow meters 36a and 36b, a second flow rate adjusting unit adjusts the ratio A₂ between the number of carbon atoms in the auxiliary gas and the number of oxygen atoms in the second oxygen-containing gas to 0.30<A₂<A₁ and supplies the auxiliary gas and the second oxygen-containing gas to the second injection unit 25a.

Also, the second flow meters 36a and 36b may be those capable of adjusting the auxiliary gas (or liquid hydrocarbons) and the second oxygen-containing gas to predetermined flow rates, and commercially available mass flow controllers or the like can be used, for example.

The second premixing chamber 26 uniformly mixes the auxiliary gas introduced from the pipe 28a and the second oxygen-containing gas introduced from the pipe 28b.

The connection pipe 27 supplies the auxiliary gas and the second oxygen-containing gas mixed in the second premixing chamber 26 (hereinafter also referred to as a “second mixed gas”) to the second injection unit 25a while penetrating an upper portion of the circumferential wall portion 2a of the reacting furnace 2. The connection pipe 27 may pass through the upper wall portion 2b of the reacting furnace 2 to supply the second mixed gas to the second injection unit 25a. The second injection unit 25a injects the second nixed gas supplied through the connection pipe 27 downward (in the direction toward the exhaust gas discharge port 30d) from the second injection ports 22a.

Further, a partitioning portion 29 is provided between the first injection unit 23c and the second injection unit 25a. The partitioning portion 29 has a partition wall 29a that protrudes from between the first injection ports 21a and the second injection ports 22a in the tip surfaces of the first injection unit 23c and the second injection unit 25a further downward from first injection ports 21a and the second injection ports 22a.

The partitioning portion 29 may be configured integrally with a heat insulating member 30 disposed inside the reacting furnace 2. The heat insulating member 30 has a cylindrical circumferential wall 30a disposed along the circumferential wall portion 2a on an inner side of the reacting furnace 2, a bottom wall 30b disposed along the lower wall portion 2c on the inner side of the reacting furnace 2, and a ceiling wall 30c that closes an upper portion of the circumferential wall 30a.

The burner holder 23 and the second injection unit 25a cause the first injection ports 21a and the second injection ports 22a to face an inside of the heat insulating member 30 while passing through the ceiling wall 30c. In addition, the exhaust gas discharge port 30d that communicates with the first pipe 6 is provided in the bottom wall 30b. Also, as a material of the heat insulating member 30, an alumina refractory brick or an alumina monolithic refractory material are exemplary examples.

Further, an ignition mechanism 31 for igniting the raw material gas and the auxiliary gas is provided in the vicinity of a position of the reacting furnace 2 to which the first pipe 6 is connected.

The burner 9A and the burner 10A of the present embodiment having the above configurations incompletely combust the raw material gas while injecting the raw material gas and the first oxygen-containing gas from the above-described first injection ports 21a to form the first combustion flame for generating the soot-like substances containing fullerenes in the reacting furnace 2, and at the same time, combust the auxiliary gas while injecting the auxiliary gas and the second oxygen-containing gas from the above-described second injection ports 22a to form the second combustion flame (preferably a complete combustion flame) having a higher temperature than the first combustion flame, thereby heating the inside of the reacting furnace 2.

Thus, in the fullerene production device 1 including the burner 9A and the burner 10A of the present embodiment, the inside of the reacting furnace 2 can be kept at a high temperature, and yields of the fullerenes contained in the generated soot-like substances can be improved.

Also, in the burner 9A and the burner 10A of the present embodiment, by providing the partitioning portion 29 between the first injection unit 23c (first injection ports 21a) and the second injection unit 25a (second injection ports 22a) described above, it is possible to prevent mixing of the first combustion flame and the second combustion flame, which are injected in the same direction. Thus, it is possible to prevent the fullerenes contained in the generated soot-like substances from being combusted by the second combustion flame.

### Second Embodiment

Next, the fullerene production device 1 according to a second embodiment of the present invention will be described.

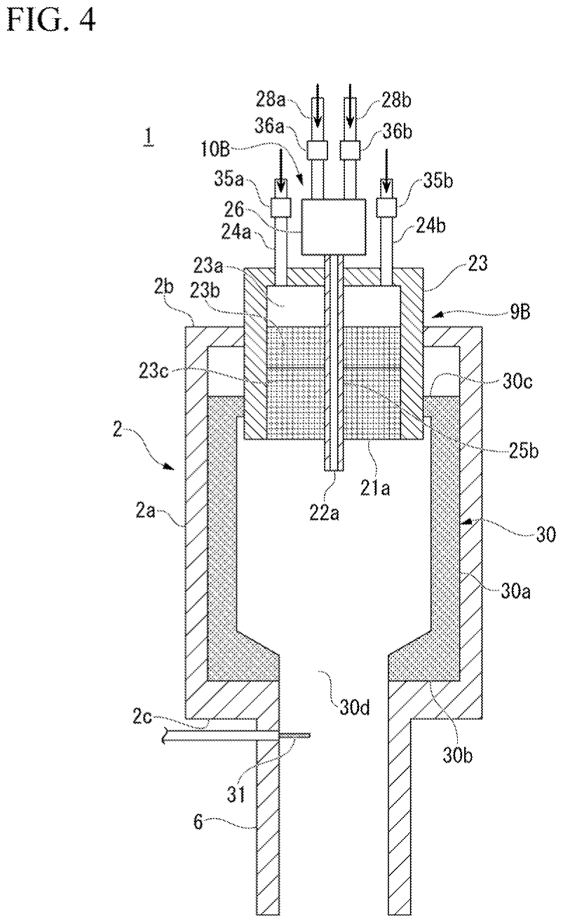

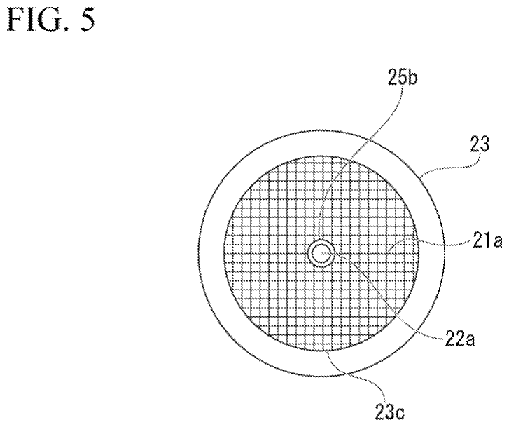

The fullerene production device 1 according to the second embodiment of the present invention includes the burner 9 (hereinafter distinguished as a “burner 9B”) and the burner 10 (hereinafter distinguished as a “burner 10B”) shown in FIGS. 4 and 5.

Also, FIG. 4 is a cross-sectional view showing a configuration of the reacting furnace 2 including the burner 9B and the burner 10B. FIG. 5 is a plan view showing configurations of tip surfaces of the first injection unit 23c of the burner 9B and a second injection unit 25b of the burner 10B, which will be described later. Further, in the following description, description of the same portions as those of the burner 9A and the burner 10A will be omitted, and the same reference numerals will be applied thereto in the drawings.

In the present embodiment, as shown in FIG. 4, the burner 10B has a tubular second injection unit 25b. The second injection unit 25b is provided at an inner center of the burner holder 23 and penetrates the first premixing chamber 23a, the pressure accumulation chamber 23b, and the first injection unit 23c in the vertical direction. Thus, the second injection unit 25b is surrounded by the first injection unit 23c. Also, as shown in FIG. 5, a second injection port 22a is provided on a tip surface of the second injection unit 25b and is surrounded by the first injection ports 21a of the first injection unit 23c. In addition, the second injection unit 25b is directly connected to the second premixing chamber 26.

The burner 9B has the same structure as the burner 9A except that the first premixing chamber 23a, the pressure accumulation chamber 23b, and the first injection unit 23c are penetrated by the second injection unit 25b in the vertical direction.

Further, a tip (lower end) of the second injection unit 25b protrudes downward from a tip (lower end) of the first injection unit 23c. Thus, positions of the first injection ports 21a and the second injection port 22a in an injecting direction (a direction toward the exhaust gas discharge port 30d) are different from each other. That is, the second injection port 22a is located below the first injection ports 21a.

The burner 9B and the burner 10B of the present embodiment having the above configurations incompletely combust the raw material gas while injecting the raw material gas and the first oxygen-containing gas from the above-described first injection ports 21a to form the first combustion flame for generating the soot-like substances containing fullerenes in the reacting furnace 2, and at the same time, combust the auxiliary gas while injecting the auxiliary gas and the second oxygen-containing gas from the above-described second injection port 22a to form the second combustion flame (preferably a complete combustion flame) having a higher temperature than the first combustion flame, thereby heating the inside of the reacting furnace 2.

Thus, in the fullerene production device 1 including the burner 9B and the burner 10B of the present embodiment, the inside of the reacting furnace 2 can be kept at a high temperature, and yields of the fullerenes contained in the generated soot-like substances can be improved.

Further, in the burner 9B and the burner 10B of the present embodiment, by adjusting the positions of the first injection ports 21a and the second injection port 22a in the injecting direction to be different from each other, it is possible to prevent mixing of the first combustion flame and the second combustion flame, which are injected in the same direction. Thus, it is possible to prevent the fullerenes contained in the generated soot-like substances from being combusted by the second combustion flame.

### Third Embodiment

Next, the fullerene production device 1 according to a third embodiment of the present invention will be described.

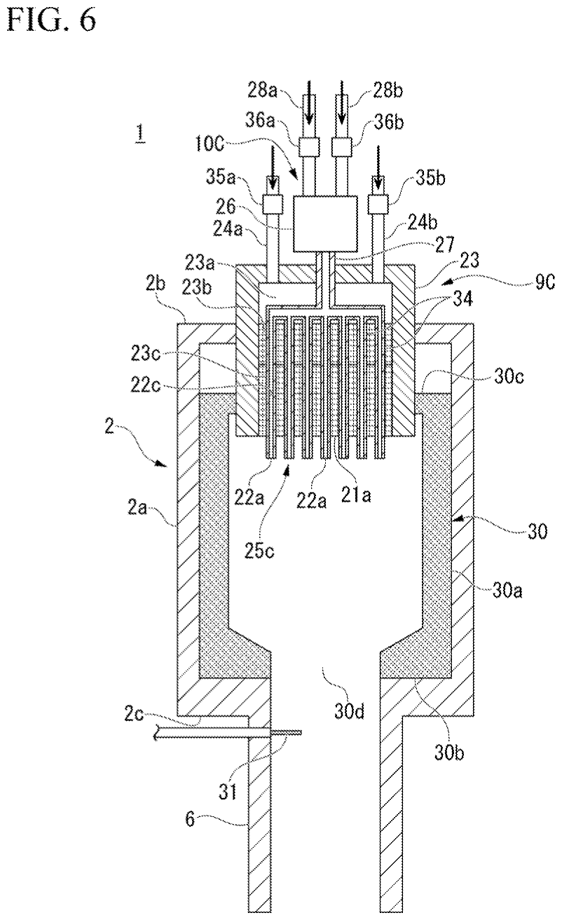

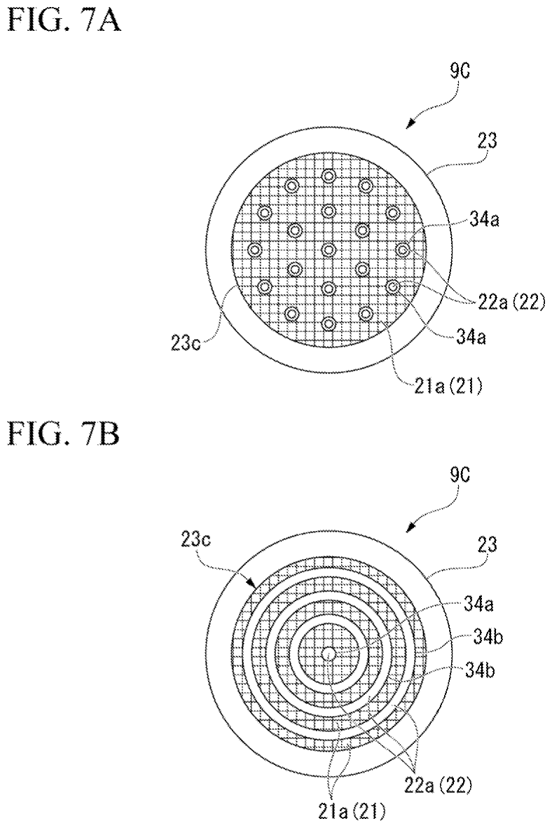

The fullerene production device 1 according to the third embodiment of the present invention includes the burner 9 (hereinafter distinguished as a “burner 9C”) and a burner 10 (hereinafter distinguished as a “burner 10C”) shown in FIGS. 6 and 7.

Also, FIG. 6 is a cross-sectional view showing a configuration of the reacting furnace 2 including the burner 9C and the burner 10C. FIGS. 7A and 7B are plan views illustrating configurations of tip surfaces of the first injection unit 23c of the burner 9C and a second injection unit 25c of the burner 10B, which will be described later. Further, in the following description, description of the same portions as those of the burner 9A and the burner 10A will be omitted, and the same reference numerals will be applied thereto in the drawings.

In the present embodiment, as shown in FIG. 6, the burner 10C has the second injection unit 25c provided inside the burner holder 23. The second injection unit 25c has a plurality of nozzles 34 branched from the connection pipe 27. The nozzles 34 are disposed while penetrating the pressure accumulation chamber 23b and the first injection unit 23c in the vertical direction. In addition, the connection pipe 27 connects the second injection unit 25c to the second premixing chamber 26 while penetrating an upper central portion of the burner holder 23.

Specifically, the nozzles 34 may be, for example, tubular or cylindrical with certain thicknesses. The second injection ports 22a are disposed on tip surfaces of the nozzles 34. In addition, in a case in which the nozzles 34 are cylindrical, passages 22c are provided inside the nozzles 34 to connect the connection pipe 27 to the second injection ports 22a. The second injection unit 25c may include either tubular nozzles 34 (hereinafter also referred to as “nozzles 34a”) or cylindrical nozzles 34 (hereinafter also referred to as “nozzles 34b”), or may include both.

For example, the second injection unit 25c of the burner 10C shown in FIG. 7A includes a plurality of nozzles 34a. On the tip surfaces of the first injection unit 23c and the second injection unit 25c, each of the nozzles 34a has a second injection port 22a opening in a circular shape. Thus, the second injection unit 25c (second injection ports 22a) is surrounded by the first injection unit 23c (first injection ports 21a).

On the other hand, the second injection unit 25c of the burner 10C shown in FIG. 7B has one nozzle 34a disposed at a central portion thereof, and a plurality of nozzles 34b disposed around the nozzle 34a. On the tip surfaces of the first injection unit 23c and the second injection unit 25c, the nozzle 34a has a plurality of second injection ports 22a opening in circular shapes, and the nozzles 34b have a plurality of second injection ports 22a opening in ring shapes.

In addition, the nozzles 34a (second injection ports 22a) is surrounded by the first injection unit 23c (first injection ports 21a), and the nozzles 34b (second injection port 22a) and parts of the first injection unit 23c (first injection ports 21a) are arranged alternately in concentric circle shapes.

The burner 9C has the same structure as the burner 9A except that the first premixing chamber 23a, the pressure accumulation chamber 23b, and the first injection unit 23c are penetrated by the connection pipe 27 and the nozzles 34 in the vertical direction.

Also, tips (lower ends) of the nozzles 34 protrude downward from the tip (lower end) of the first injection unit 23c. Thus, positions of the first injection ports 21a and the second injection ports 22a in the injecting direction (the direction toward the exhaust gas discharge port 30d) are different from each other. That is, the second injection ports 22a are located below the first injection ports 21a.

The burner 9C and the burner 10C of the present embodiment having the above configurations incompletely combust the raw material gas while injecting the raw material gas and the first oxygen-containing gas from the above-described first injection ports 21a to form the first combustion flame for generating the soot-like substances containing fullerenes in the reacting furnace 2, and at the same time, combust the auxiliary gas while injecting the auxiliary gas and the second oxygen-containing gas from the above-described second injection ports 22a to form the second combustion flame (preferably a complete combustion flame) having a higher temperature than the first combustion flame, thereby heating the inside of the reacting furnace 2.

Thus, in the fullerene production device 1 including the burner 9C and the burner 10C of the present embodiment, the inside of the reacting furnace 2 can be kept at a high temperature, and the yields of the fullerenes contained in the generated soot-like substances can be improved.

Also, in the burner 9C and the burner 10C of the present embodiment, by adjusting the positions of the first injection ports 21a and the second injection ports 22a in the injecting direction to be different from each other, it is possible to prevent mixing of the first combustion flame and the second combustion flame, which are injected in the same direction. Thus, it is possible to prevent the fullerenes contained in the generated soot-like substances from being combusted by the second combustion flame.

### Fourth Embodiment

Next, the fullerene production device 1 according to a fourth embodiment of the present invention will be described.

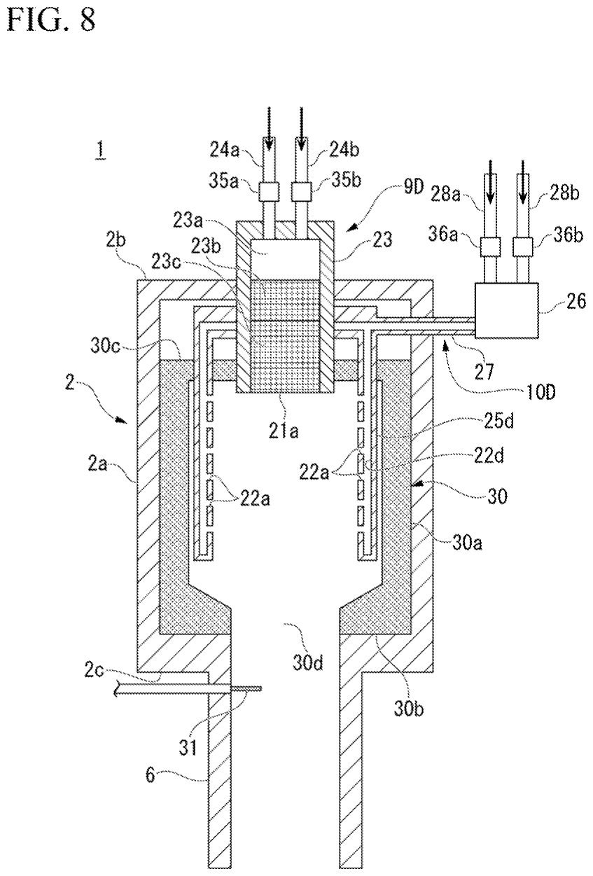

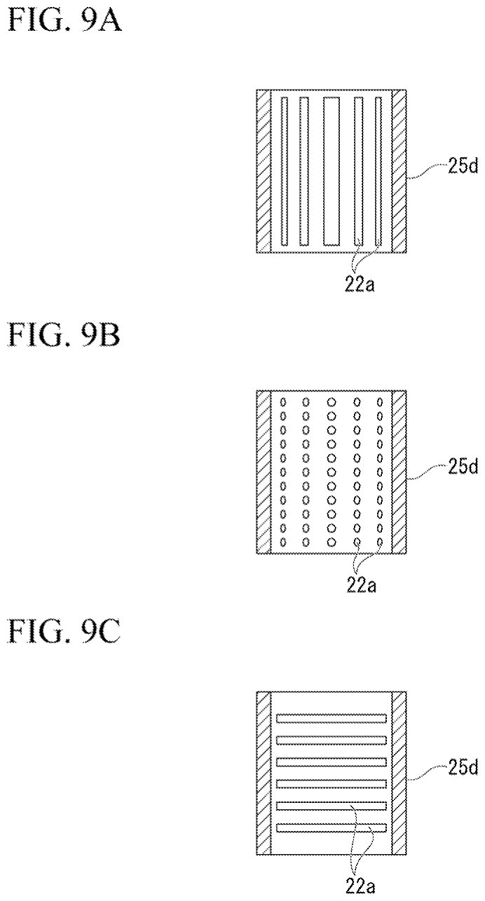

The fullerene production device 1 according to the fourth embodiment of the present invention includes the burner 9 (hereinafter referred to as a “burner 9D”) and the burner 10 (hereinafter referred to as a “burner 10D”) shown in FIGS. 8 and 9.

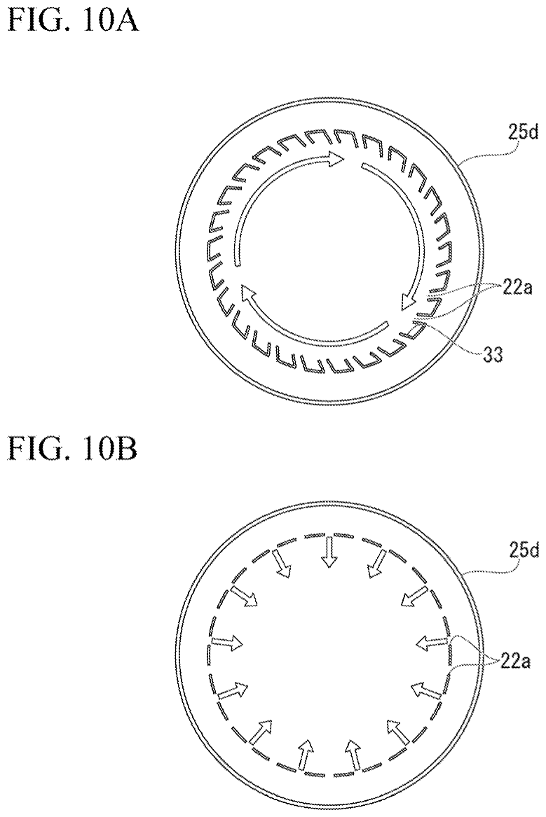

Also, FIG. 8 is a cross-sectional view showing a configuration of the reacting furnace 2 including the burner 9D and the burner 10D. FIGS. 9A, 9B, and 9C are longitudinal cross-sectional views illustrating shapes and arrangement of a second injection unit 25d and second injection ports 22a provided in the burner 10D. FIGS. 10A and 10B are cross-sectional views illustrating arrangement of the second injection ports 22a of the second injection unit 25d provided in the burner 10D. Further, in the following description, description of the same portions those of the burner 9A and the burner 10A will be omitted, and the same reference numerals will be applied thereto in the drawings.

The burner 9D of the present embodiment has the same configuration as the burner 9A.

The burner 10D has the second injection unit 25d as shown in FIG. 8. The second injection unit 25d has a cylindrical shape that extends downward from a position surrounding the burner holder 23 and is provided around the reacting furnace 2 between one end side (upper wall portion 2b side) and the other end side (lower wall portion 2c side) thereof.

A plurality of second injection ports 22a are arranged side by side on an inner circumferential surface of the second injection unit 25d. In addition, passages 22d that connects the connection pipe 27 to the second injection ports 22a are provided inside the second injection unit 25d. Thus, the second injection unit 25d can inject the auxiliary gas into the reacting furnace 2 from the second injection ports 22a.

The second injection ports 22a on the inner circumferential surface of the second injection unit 25d may have shapes and arrangement as shown in FIGS. 9A, 9B, and 9C in an axial direction of the second injection unit 25d. For example, the plurality of second injection ports 22a shown in FIG. 9A are each opened in slit shapes in the axial direction of the second injection unit 25d and arranged side by side in the circumferential direction of the second injection unit 25d.

On the other hand, the plurality of second injection ports 22a shown in FIG. 9B are each opened in circular shapes and arranged side by side in the circumferential and axial directions of the second injection unit 25d.

On the other hand, the plurality of second injection ports 22a shown in FIG. 9C are each opened in slit shapes in the circumferential direction of the second injection unit and arranged side by side in the axial direction of the second injection unit 25d.

Further, in a case in which the second injection unit 25d has the plurality of second injection ports 22a as shown in FIGS. 9A and 9B in the circumferential direction, the plurality of second injection ports 22a may be formed as shown in FIGS. 10A and 10B. For example, the plurality of second injection ports 22a shown in FIG. 10A are formed by protruding portions 33 that open obliquely in the same direction on the inner circumferential surface of the second injection unit 25d. Thus, it is possible to form a spiral flow of the auxiliary gas injected from each of the second injection ports 22a.

On the other hand, the plurality of second injection ports 22a shown in FIG. 10B open toward a center of the reacting furnace 2 in the circumferential direction of the second injection unit 25d. Thus, it is possible to inject the auxiliary gas injected from each second injection port 22a toward the center of the reacting furnace 2.

In the present embodiment, the first injection unit 23c can inject the raw material gas from the first injection ports 21a at one end side (an upper wall portion 2b side) of the reacting furnace 2 toward the other end side (lower wall portion 2c side). The second injection unit 25d can inject the auxiliary gas from the second injection ports 22a around between the one end side (upper wall part 2b side) and the other end side (lower wall part 2c side) of the reacting furnace 2.

The burner 9D and the burner 10D of the present embodiment having the above configurations incompletely combust the raw material gas while injecting the raw material gas and the first oxygen-containing gas from the above-described first injection ports 21a to form the first combustion flame for generating the soot-like substances containing fullerenes in the reacting furnace 2, and at the same time, combust the auxiliary gas while injecting the auxiliary gas and the second oxygen-containing gas from the above-described second injection ports 22a to form the second combustion flame (preferably a complete combustion flame) having a higher temperature than the first combustion flame, thereby heating the inside of the reacting furnace 2.

Thus, in the fullerene production device 1 including the burner 9D and the burner 10D of the present embodiment, the inside of the reacting furnace 2 can be kept at a high temperature, and yields of the fullerenes contained in the generated soot-like substances can be improved.

Also, the present invention is not necessarily limited to the above embodiments, and various modifications can be made without departing from the scope of the present invention.

### EXAMPLES

Effects of the present invention will be made clearer by the following examples. Also, the present invention is not limited to the following examples and can be modified as appropriate without changing the gist thereof.

[Calculation of Fullerenes]

In Examples 1 to 7 and Comparative Example 1 below, the total yields of C₆₀ and C₇₀ was calculated as the fullerene yields.

In addition, according to “JIS Z 8981,” the amounts of C₆₀ and C₇₀ contained in the recovered soot-like substances was measured as follows.

Specifically, 15 g of 1,2,3,5-tetramethylbenzene (TMB) was added to 0.05 g of the recovered soot-like substances, and then ultrasonic treatment was performed for 15 minutes to obtain a suspension. After the obtained suspension was filtered with a membrane filter with a pore size of 0.5 the filtrate (sample solution) was analyzed by high performance liquid chromatography (HPLC) to quantify C₆₀ and C₇₀, and the amounts [% by mass] of C₆₀ and C₇₀ contained in the soot-like substances were calculated.

Here, when the amounts of C₆₀ and C₇₀ contained in the soot-like substances were calculated, a calibration curve prepared in advance from TMB solutions of multiple known concentrations of C₆₀ and C₇₀ was used.

The HPLC measurement conditions are as follows.

Device: Infinity 1260 (manufactured by Agilent)

Amount of injection of sample solution: 5 μL

Eluent: toluene (47% by volume)/methanol (53% by volume) mixed solvent

Flow rate of eluent: 1 ml/min

Column: YMC-Pack ODS-AM 100*4.6 mm ID S-3 μm, 12 nm

Measurement temperature: 40° C.

Detector: UV 325 nm (JIS)

Next, from the amounts of fullerenes contained in the soot-like substances (total amounts of C₆₀ and C₇₀), the fullerene yields [% by mass] was calculated using the formula {(amount of soot-like substances recovered [g])/(amount of consumption of raw material gas [g])}×(amounts of fullerenes [% by mass]).

“Measurement of Internal Temperature in Reacting Furnace”

Temperatures inside the reacting furnace 2 of Examples 1 to 7 and Comparative Example 1 below were measured with a high-performance monochromatic thermometer Marathon MM (manufactured by Raytec Co., Ltd.) using the sapphire glass window 2d.

### Example 1

Fullerenes were produced using the fullerene production device 1 having the reacting furnace 2 shown in FIG. 2. The tip portion of the second injection unit 25a has the structure shown in FIG. 3A.

Here, the reacting furnace 2 is a vertically disposed alumina cylinder having a height of 1000 mm and an inner diameter of 200 mm. The burner 9A is provided to penetrate the upper wall portion 2b of the reacting furnace 2. The sapphire glass window 2d of 60 mm×60 mm is provided in the reacting furnace 2, and an upper side of the sapphire glass window 2d is parallel to the tip surface of the first injection unit 23c. The first injection unit 23c is configured of a disc-shaped porous ceramic sintered body having a diameter of 100 mm, and 60 to 80 holes (first injection ports 21a) having a diameter of about 0.5 mm to 1.0 mm are formed in the ceramic sintered body per 1 cm².

The second injection unit 25a of the burner 10A is a stainless-steel cylinder having an inner diameter of 160 mm and has a cooling water channel therein. 40 second injection ports 22a having a diameter of 10 mm are evenly disposed on the tip surface of the second injection unit 25a. In the vertical direction, the tip surface of the second injection unit 25a and the tip surface of the first injection unit 23c are at the same height. In addition, the partition wall 29a made of alumina protruding from between the first injection unit 23c and the second injection unit 25a downward by 40 mm from the tip end surfaces of the first injection unit 23c and the second injection unit 25a is provided.

Toluene was used for the raw material gas, and pure oxygen gas (purity 99.9% by volume) was used for the first oxygen-containing gas. Here, toluene was heated by a vaporizer provided in the pipe 24a, made gaseous, and then supplied to the burner 9A.

A flow rate of toluene was controlled by a mass controller (AeraSFC168, manufactured by Hitachi Metals, Ltd.), which is the first flow meter 35a. A flow rate of pure oxygen gas was controlled by a mass flow meter (mass controller Aera, FC-7810CD, manufactured by Hitachi Metals, Ltd.), which is the first flow meter 35b.

The flow rate of toluene was set at 20 g/min, and the flow rate of pure oxygen gas was set at 13 NL/min. Also, the ratio A₁ between the number of carbon atoms in the raw material gas supplied to the reacting furnace 2 and the number of oxygen atoms in the first oxygen-containing gas was 1.31.

Toluene was used for the auxiliary gas, and pure oxygen gas (purity 99.9% by volume) was used for the second oxygen-containing gas. Here, toluene was heated by a vaporizer provided in the pipe 28a, made gaseous, and then supplied to the burner 10A.

A flow rate of toluene was controlled by a mass controller (AeraSFC168, manufactured by Hitachi Metals, Ltd.), which is the second flow meter 36a. A flow rate of the pure oxygen gas was controlled by a mass flow meter (mass controller Aera, FC-7810CD, manufactured by Hitachi Metals, Ltd.), which is the second flow meter 36b.

The flow rate of toluene was set at 20 g/min, and the flow rate of pure oxygen gas was set at 18 NL/min. Further, the pressure inside the reacting furnace 2 was set to 5.33 kPa when the fullerenes were generated. Also, the ratio of the number of carbon atoms in the auxiliary gas supplied to the reacting furnace 2 to the number of oxygen atoms in the second oxygen-containing gas: A₂ was 0.95, satisfying 0.30<A₂ (0.95)<A₁ (1.31).

The temperature inside the reacting furnace 2 when the fullerenes were generated was 1120° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 1.2%.

### Example 2

Fullerenes were generated in the same manner as in Example 1, except that the flow rate of toluene serving as the auxiliary gas was set at 20 g/min and the flow rate of pure oxygen serving as the second oxygen-containing gas was set at 21 NL/min. Also, the ratio of the number of carbon atoms in the auxiliary gas supplied to the reacting furnace 2 to the number of oxygen atoms in the second oxygen-containing gas: A₂ was 0.81, satisfying 0.30<A₂ (0.81)<A₁ (1.31).

The temperature of the reacting furnace 2 when the fullerenes were generated was 1680° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 1.5%.

### Example 3

Fullerenes were generated in the same manner as in Example 1, except that the flow rate of toluene servings as the auxiliary gas was set at 20 g/min and the flow rate of pure oxygen serving as the second oxygen-containing gas was set at 25 NL/min. Further, the ratio A₂ between the number of carbon atoms in the auxiliary gas supplied to the reacting furnace 2 and the number of oxygen atoms in the second oxygen-containing gas was 0.68, satisfying 0.30<A₂ (0.68)<A₁ (1.31).

The temperature of the reacting furnace 2 when the fullerenes were generated was 1870° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 2.1%.

### Example 4

Fullerenes were generated in the same manner as in Example 5, except that 1-hexene was used for the auxiliary gas, a flow rate of 1-hexene was set at 13 g/min, and the flow rate of pure oxygen for the second oxygen-containing gas was set at 25 NL/min. The ratio of the number of carbon atoms in the auxiliary gas supplied to the reacting furnace 2 to the number of oxygen atoms in the second oxygen-containing gas: A₂ was 0.42, satisfying 0.30<A₂ (0.42)<A₁ (1.31).

The temperature of the reacting furnace 2 when the fullerenes were generated was 1810° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 1.9%.

### Example 5

Fullerenes were produced using the fullerene production device 1 having the reacting furnace 2 shown in FIG. 4.

The second injection unit 25b of the burner 10B is a zirconia tube. The circular second injection ports 22a having a diameter of 20 mm are provided at the tip portion of the second injection unit 25b. In the vertical direction, the tip surface of the second injection unit 25b is 40 mm lower than the tip surface of the first injection unit 23c.

The fullerenes were generated in the same manner as in Example 1, except that the flow rate of toluene serving as the auxiliary gas was set at 20 g/min and the flow rate of pure oxygen serving as the second oxygen-containing gas was set at 21 NL/min. Also, the ratio of the number of carbon atoms in the auxiliary gas supplied to the reacting furnace 2 to the number of oxygen atoms in the second oxygen-containing gas: A₂ was 0.81, satisfying 0.30<A₂ (0.81)<A₁ (1.31).

The temperature of the reacting furnace 2 when the fullerenes were generated was 1300° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 1.1%.

### Example 6

Fullerenes were generated in the same manner as in Example 4, except that the flow rate of toluene serving as the auxiliary gas was set at 20 g/min and the flow rate of pure oxygen serving as the second oxygen-containing gas was set at 25 NL/min. Also, the ratio of the number of carbon atoms in the auxiliary gas supplied to the reacting furnace 2 to the number of oxygen atoms in the second oxygen-containing gas: A₂ was 0.68, satisfying 0.30<A₂ (0.68)<A₁ (1.31).

The temperature of the reacting furnace 2 when the fullerenes were generated was 1500° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 1.4%.

### Example 7

Fullerenes were produced using the fullerene production device 1 having the reacting furnace 2 shown in FIG. 6.

The tip portion of the second injection unit 25c has the structure as shown in FIG. 7A. The nozzles 34a of the second injection unit 25c of the burner 10C are made of zirconia. The circular second injection ports 22a having a diameter of 8 mm are disposed at the tip portions of the nozzles 34a. There are 16 nozzles 34a of the second injection unit 25c, which are disposed at equal distances from each other. In the vertical direction, the tip surface of the second injection unit 25c is 40 mm lower than the tip surface of the first injection unit 23c.

The fullerenes were generated in the same manner as in Example 1, except that the flow rate of toluene serving as the auxiliary gas was set at 20 g/min and the flow rate of pure oxygen serving as the second oxygen-containing gas was set at 25 NL/min. Also, the ratio of the number of carbon atoms in the auxiliary gas supplied to the reacting furnace 2 to the number of oxygen atoms in the second oxygen-containing gas: A₂ was 0.68, satisfying 0.30<A₂ (0.68)<A₁ (1.31).

The temperature of the reacting furnace 2 when the fullerenes were generated was 1830° C. In addition, under the above conditions, the fullerene production device 1 was operated for 3 hours, and the generated soot-like substances were recovered from the recovery mechanism 3. Further, the fullerene yields were calculated after the amounts of fullerenes contained in the recovered soot-like substances were measured by the method described in the above [Calculation of fullerenes]. The resulting fullerene yields were 1.9%.

### Example 8

Fullerenes were produced using the fullerene production device 1 having the reacting furnace 2 shown in FIG. 8.

The burner 10D has the second injection ports 22a shown in FIG. 9A. Further, the second injection ports 22a open as shown in FIG. 10B. The second injection unit 25d of the burner 10D is a zirconia cylinder having an inner diameter of 160 mm and a height of 400 mm Sixteen slit-shaped second injection ports 22a having a width of 8 mm and a height of 45 mm are disposed at equal distances from each other on the inner circumferential surface of the second injection unit 25d. In the vertical direction, upper sides of the slit-shaped second injection ports 22a are at the same height as the tip surface of the burner 9D.

The flow rate of toluene serving as the auxiliary gas was set at 20 g/min, and the flow rate of pure oxygen gas serving as the second oxygen-containing gas was set at 25 NL/min. The fullerenes were generated in the same manner as in Example 1 except for the above. Also, the ratio of the number of carbon atoms in the auxiliary gas supplied to the reacting furnace 2 to the number of oxygen atoms in the second oxygen-containing gas: A₂ was 0.68, satisfying 0.30<A₂ (0.68)<A₁ (1.31).

The temperature of the reacting furnace 2 when the fullerenes were generated was 1960° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 2.2%.

### Comparative Example 1

Fullerenes were generated in the same manner as in Example 1, except that the fullerenes were produced using the fullerene production device 1 without the burner 10A. The ratio A₁ between the number of carbon atoms in the raw material gas supplied to the reacting furnace 2 and the number of oxygen atoms in the first oxygen-containing gas was 1.31.

The temperature of the reacting furnace 2 when the fullerenes were generated was 500° C. Further, under the above conditions, the fullerene production device 1 was operated for 3 hours, and the generated soot-like substances were recovered from the recovery mechanism 3. In addition, the fullerene yields were calculated after the amounts of fullerenes contained in the recovered soot-like substances were measured by the method described in the above [Calculation of fullerenes]. The resulting fullerene yields were 0.6%.

From the above, it can be seen that Examples 1 to 7 have improved fullerene yields as compared to Comparative Example 1. That is, it is possible to improve the fullerene yields by keeping the inside of the reacting furnace 2 at a high temperature with the second combustion flame.

### REFERENCE SIGNS LIST

1 Fullerene production device
2 Reacting furnace
3 Recovery mechanism
4 Cooling mechanism
5 Decompression mechanism (vacuum pump)
6 First pipe
7 Second pipe
8 Third pipe
9, 9A to 9D Burner
10, 10A to 10D Burner
11 Filter
12 Collector
13 Electromagnetic valve
14 Tank
15 Discharge valve
16 Drain
21a First injection port
22a Second injection port
23 Burner holder
23a First premixing chamber
23b Pressure accumulation chamber
23c First injection unit
24a Pipe
24b Pipe
25a to 25d Second injection unit
26 Second premixing chamber
27 Connection pipe
28a Pipe
28b Pipe
29 Partitioning portion
30 Heat insulating member
31 Ignition mechanism
34, 34a, 34b Nozzle
35a, 35b First flow meter (first flow rate adjusting unit)
36a, 36b Second flow meter (second flow rate adjusting unit)

1. A fullerene production device comprising:
a reacting furnace in which fullerenes are generated through incomplete combustion of a raw material gas containing a hydrocarbon;
a first injection unit configured to incompletely combust the raw material gas while injecting the raw material gas and a first oxygen-containing gas into the reacting furnace to form a first combustion flame; and
a second injection unit configured to combust an auxiliary gas containing a hydrocarbon that is the same as or different from that in the raw material gas while injecting the auxiliary gas and a second oxygen-containing gas into the reacting furnace to form a second combustion flame.

2. The fullerene production device according to claim 1, further comprising:
a first flow rate adjusting unit configured to adjust a ratio A₁ of the number of carbon atoms in the raw material gas to the number of oxygen atoms in the first oxygen-containing gas to 0.60 to 2.00 to supply the raw material gas and the first oxygen-containing gas to the first injection unit; and
a second flow rate adjusting unit configured to adjust a ratio A₂ of the number of carbon atoms in the auxiliary gas to the number of oxygen atoms in the second oxygen-containing gas to 0.30<A₂<A₁ to supply the auxiliary gas and the second oxygen-containing gas to the second injection unit.

3. The fullerene production device according to claim 1, wherein one of the first injection unit and the second injection unit is disposed to surround the other.

4. The fullerene production device according to claim 1, wherein the reacting furnace comprises a plurality of the first injection units and a plurality of the second injection units, wherein at least a part of the first injection units and at least a part of the second injection units are alternately arranged in concentric circle shapes.

5. The fullerene production device according to claim 1, wherein a partitioning portion is provided between the first injection unit and the second injection unit.

6. The fullerene production device according to claim 1,
wherein the first injection unit injects the raw material gas from a first end side of the reacting furnace toward a second end side thereof, and
the second injection unit injects the auxiliary gas from a periphery between the first end side and the second end side of the reacting furnace.

7. The fullerene production device according to claim 1, further comprising a decompression mechanism configured to decompress an inside of the reacting furnace while performing suction from the inside of the reacting furnace.

8. A fullerene production method characterized by including a step of generating fullerenes in a reacting furnace through incomplete combustion of a raw material gas containing a hydrocarbon,
wherein, in the step of generating fullerenes, while the raw material gas and a first oxygen-containing gas are injected into the reacting furnace, the raw material gas is incompletely combusted to form a first combustion flame,
while an auxiliary gas containing a hydrocarbon that is the same as or different from that in the raw material gas and a second oxygen-containing gas are injected into the reacting furnace, the auxiliary gas is combusted to form a second combustion flame, thereby heating an inside of the reacting furnace,
a ratio A₁ of the number of carbon atoms in the raw material gas to the number of oxygen atoms in the first oxygen-containing gas is set to 0.60 to 2.00, and
a ratio A₂ of the number of carbon atoms in the auxiliary gas to the number of oxygen atoms in the second oxygen-containing gas is set to 0.30<A₂<A₁.

9. The fullerene production method according to claim 8, wherein a temperature inside the reacting furnace is set to 1000 to 2000° C.

10. The fullerene production method according to claim 8, wherein, in the step of generating fullerenes, the inside of the reacting furnace is set in a decompressed state while suction from the inside of the reacting furnace is performed.

11. The fullerene production method according to claim 10, wherein a pressure inside the reacting furnace is set to 1 to 30 kPa.
